(19) United States
(12) Patent Application Publication
(10) Pub. No.: US 2016/0299561 A1
(43) Pub. Date: Oct. 13, 2016

(54) SWITCHING NETWORK INTERFACE CONTROLLER ADD-IN CARD CONFIGURED TO OPERATE DURING SLEEP MODES OF A HOST COMPUTING DEVICE

(71) Applicant: Transition Networks, Inc., Minnetonka, MN (US)

(72) Inventors: Allen C. Middleton, St. Louis Park, MN (US); Bill J. Revering, Anoka, MN (US); Curtis J. Carlson, Maple Grove, MN (US)

(21) Appl. No.: 15/095,521

(22) Filed: Apr. 11, 2016

Related U.S. Application Data
(60) Provisional application No. 62/145,925, filed on Apr. 10, 2015.

(51) Int. Cl. G06F 1/32; G06F 1/26

(52) U.S. Cl. CPC G06F 1/3296; G06F 1/266

(57) ABSTRACT

Disclosed embodiments include a network interface controller (NIC) card, such as a media converter card, configured to operate during levels of sleep of a computing device to which the NIC card is connected. This allows functionality of a peripheral device, such as an IP phone, to persist when the computing device enters a low power sleep mode of operation.

This application claims the benefit of U.S. Provisional Application No. 62/145,925, filed Apr. 10, 2015.

### BACKGROUND OF THE INVENTION

The present invention relates to media conversion cards for desktop or other personal computers (PCs) or other computers which convert data between two different transmission media types, such as between fiber and copper.

Media converters are commonly use to provide media conversion between different media types within local area networks (LANs), wide area networks (WANs), or when interfacing between networks. An important media conversion technology involves conversion between copper and fiber networks or devices. Increasingly, fiber optic networks are being extended to connect the fiber network directly to computing devices such as PCs. Utilizing fiber connection all of the way to the PC can provide benefits such as data security and/or increased maximum cable distance benefits.

Fiber network conversion devices can be used in conjunction with PCs to convert data between the fiber network and the PC's internal copper network. Also, increasingly, fiber optic connections are being provided at the PC to accommodate internet protocol (IP) phones. The IP phones frequently have copper network connections through a port on the media conversion device, such as an RJ-45 port.

Network interface controllers (NICs), which are also sometimes referred to as network interface cards, network adapters, LAN adapters, and by similar terms, are computer hardware components that connect a computer to a computer network. NICs can come pre-installed on computers, or can be provided with an add-in card that plugs into the computer. Ethernet port NICs are provided with many computers, but fiber network connecting NICs sometimes need to be installed using an add-in card. One primary function provided by the NIC is responding to sleep control signals sent from the host computer when entering into, or exiting from, various power savings modes.

To support IP phones, it has been common to place a media converter box near the PC, with this media converter box providing copper-to-fiber conversion, and vice-versa. The IP phones typically have RJ-45 ports for copper cable connection (e.g., a twisted pair cable). Therefore, in some instances a fiber network is connected directly to the PC for the greater security and distance benefits provided by fiber, and voice over IP (VoIP) services are provided by converting the VoIP data from the fiber network format to a copper network format, with the data provided on a twisted pair copper cable plugged into the phone's RJ-45 port. Media conversion to support an IP phone can also be provided using a combined NIC and media conversion card. Using power over Ethernet (PoE) technology and standards, some IP phones or other peripheral devices can be powered from the combined NIC and media conversion card, while others utilize separate power supplies to power these peripheral devices.

Stand-alone media converter boxes typically utilize separate power supplies. However, when media conversion functionality is implemented in an add-in card with a NIC installed in a PC, if the PC enters a low power sleep mode, the media conversion function does not continue to work. Thus, if the PC is in a sleep mode, the IP phone cannot communicate with a VoIP server and therefore phone service is lost.

The discussion above is merely provided for general background information and is not intended to be used as an aid in determining the scope of the claimed subject matter. For example, the principles here also apply to NIC cards which do not require conversion between two media types (e.g., fiber to copper), such as copper to copper PoE NIC cards.

### SUMMARY

This Summary is provided to introduce a selection of concepts in a simplified form that are further described below in the Detailed Description. This Summary is not intended to identify key features or essential features of the claimed subject matter.

Exemplary disclosed embodiments include a media converter card or a switching NIC card configured to implement media conversion functions and/or switching functions, in both full power and sleep modes of operation of a computing device to which the media converter card is connected. This allows functionality of a peripheral device, such as an IP phone, to persist when the computing device enters a low power sleep mode of operation.

In some exemplary embodiments, a media converter is disclosed. The media converter includes a connector, configured to couple to a power supply of the computer, such that the media converter is powered by the power supply; a first port configured to communicate with a first media; a second port configured to communicate with a second media; and a data converter. The data converter is configured to: convert data received at the first port into a data format communicable by the second port and the second media even when the computer is operating in a low power mode or sleep mode; and convert data received at the second port into a data format communicable by the first port and the first media even when the computer is operating in a low power mode or sleep mode.

In some exemplary embodiments, the media converter is part of a card, and the card is configured to attach to and detach from a peripheral component interconnect (PCI) bus of the computer. In other exemplary embodiments, the media converter is hardwired to the computer.

In some exemplary embodiments, the first media and the second media are different types of media. Further in some exemplary embodiments, the first media is a fiber optic cable and the second media is a copper cable.

In some exemplary embodiments, the media converter further includes a switch that provides or comprises the data converter. The switch has, in exemplary embodiments, respective ports configured to communicate with the first port and the second port. In some exemplary embodiments, the switch is an Ethernet switch.

In some exemplary embodiments, the media converter includes a network interface controller (NIC) that is configured to store data and operational parameters from the computer. The data and operational parameters from the computer include, in some embodiments, instructions regarding entry into, and exit from, a low power mode or a sleep mode of the computer.

In some exemplary embodiments, the media converter includes standby circuitry that is configured to provide power to the data converter when the computer is operating in a low power mode or sleep mode.

In some exemplary embodiments, the media converter further includes a power sourcing equipment (PSE) controller that is configured to control different modes of operation of the media converter; and a microcontroller. In some embodiments, the microcontroller is configured to: determine statuses of parts of the media converter; and instruct the PSE controller as to which mode of operation of the media converter to operate under. In some exemplary embodiments, the modes of operation of the media converter include a power over Ethernet (PoE) mode in accordance with a PoE standard and a legacy mode established prior to the existence of PoE.

In yet other exemplary embodiments, a media converter card is provided and is configured to attach to and detach from a bus of a computer. The media converter card includes, in some embodiments, a connector, configured to: couple to a first bus of a computer; and receive power from a power supply via the first bus of the computer, such that the media converter is powered by the power supply. The media converter card also includes, in exemplary embodiments, a first port configured to communicate with a fiber optic cable; a second port configured to communicate with a copper cable; a switch; and standby circuitry. In some example embodiments, the switch includes: respective ports configured to communicate with the first port and the second port; and a data converter configured to: convert data received at the first port into a data format communicable by the second port and a copper cable even when the computer is operating in a low power mode or sleep mode; and convert data received at the second port into a data format communicable by the first port and a fiber optic cable even when the computer is operating in a low power mode or sleep mode. In some exemplary embodiments, the standby circuitry is configured to: couple to a second bus of the computer and receive power via the second bus; and provide power to the switch when the computer is operating in a low power mode or sleep mode.

In some exemplary embodiments of the media converter card, the card also includes a network interface controller (NIC) that is configured to store data and operational parameters from the computer, wherein the data and operational parameters from the computer include instructions regarding entry into, and exit from, a low power mode or a sleep mode of the computer. In some embodiments, the NIC is further configured to couple to the second bus of the computer and receive power via the second bus.

In some exemplary embodiments of the media converter card, the switch is an Ethernet switch.

In yet other exemplary embodiments, a method is provided including: attaching a media converter card to a first bus and a second bus of a computer; receiving power via the first and second buses of the computer, such that the media converter is powered by the computer; communicating with a fiber optic cable by a first port of the media converter card; communicating with a copper cable by a second port of the media converter card; converting, by a switch, data received at the first port into a data format communicable by the second port and the copper cable even when the computer is operating in a low power mode or sleep mode that effects the power outputted by the first bus; converting, by a switch, data received at the second port into a data format communicable by the first port and the fiber optic cable even when the computer is operating in the low power mode or sleep mode; and providing, by standby circuitry, power to the switch when the computer is operating in the low power mode or sleep mode.

In some exemplary embodiments, the switch required by the method is an Ethernet switch.

### BRIEF DESCRIPTION OF THE DRAWINGS

FIG. 1 is a block diagram illustrating an example embodiment of a computing device having a media converter add-in card in accordance with exemplary embodiments.

FIG. 2 is a block diagram of the media converter add-in card in accordance with some exemplary embodiments.

### DETAILED DESCRIPTION

Before disclosed embodiments are explained in detail, it is to be understood that the disclosed embodiments are not limited in application to the details of construction and the arrangement of components set forth in the following description or illustrated in the following drawings. Other embodiments can be used, and the disclosed methods, apparatus and systems can be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Exemplary disclosed embodiments are implemented in a media conversion card or other types of switching NIC cards which can be included with, or provided as an add-in for, a computer such as a personal computer (PC). However, other embodiments can be implemented without a separate media conversion card or switching NIC card. For example, in an embodiment, a media converter and/or a NIC can be hardwired to the computer. The exemplary embodiments include computer implemented methods, computer readable instructions, and configured computing devices.

Although not required, disclosed embodiments are at times described in the general context of computer-executable instructions, such as program modules or apps, being executed by an electronic device such as microcontroller, a microprocessor, etc. Generally, program modules include routines, programs, objects, components, data structures, etc. that perform particular tasks or implement particular abstract data types.

In the description that follows, disclosed embodiments will be described with reference to acts and symbolic representations of operations that are performed by one or more devices, unless indicated otherwise. As such, it will be understood that such acts and operations, which are at times referred to as being computer-executed, include the manipulation by microcontrollers, microprocessors, processing units, or other circuitry of the device of electrical signals representing data in a structured form. This manipulation transforms the data or maintains it at locations in the memory system of the device, which reconfigures or otherwise alters the operation of the device in a manner well understood by those skilled in the art. The data structures where data is maintained are physical locations of the memory that have particular properties defined by the format of the data. However, while disclosed embodiments are described in the foregoing context, it is not meant to be limiting as those of skill in the art will appreciate that various of the acts and operations described hereinafter may also be implemented in hardware such as application-specific integrated circuits (ASICs), discrete circuitry components, etc.

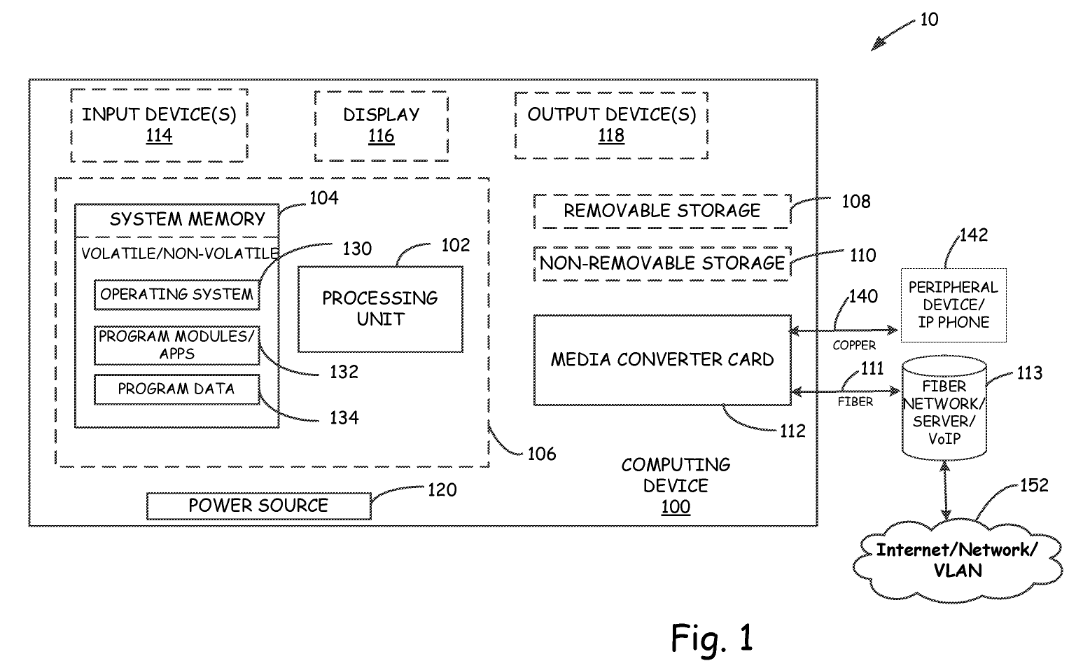

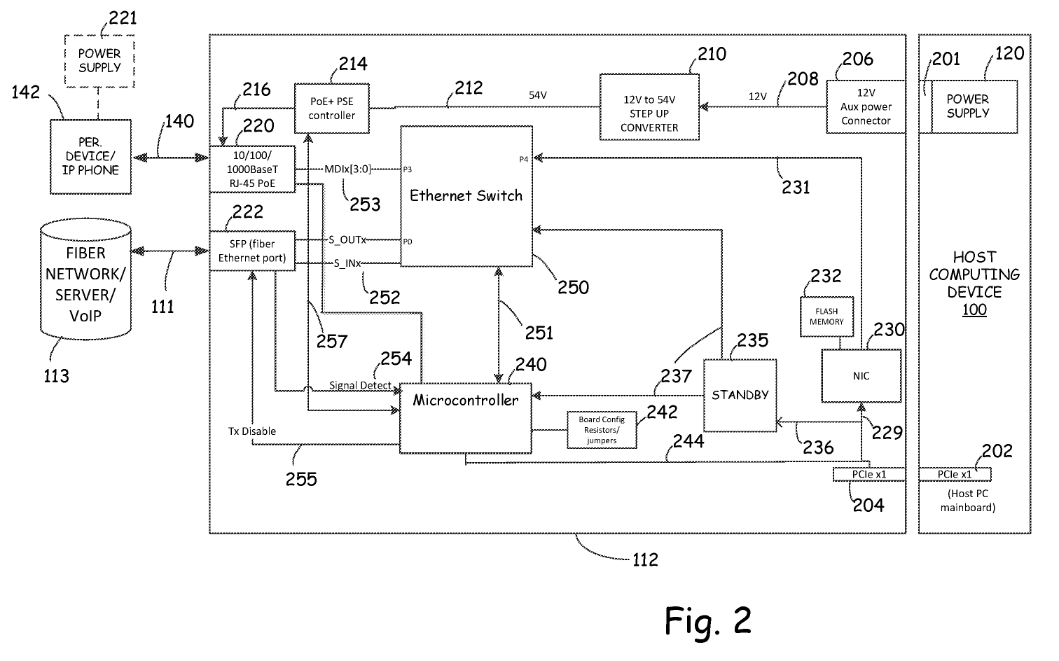

FIG. 1 shows a computing device 100, such as a PC, having a switching NIC card 112, which can be for example a PoE media converter card, and/or a copper PoE NIC card, installed therein. While disclosed embodiments are described primarily with reference to switching NIC card 112 shown in FIG. 2 being a media converter card, computing device 100 and the system 10 including computing device 100 and switching NIC card 112 in the form of a media converter card are initially described. Those of skill in the art will understand that the disclosed principles and embodiments can be implemented in other types of switching NIC cards. In its most basic configuration, the computing device 100 includes at least a processing unit 102 and a memory 104. Depending on the exact configuration and type of computing device, the memory 104 may be volatile (such as RAM), non-volatile (such as ROM, flash memory, etc.) or some combination of the two. This most basic configuration is illustrated in FIG. 1 by a dashed line 106.

Additionally, the device 100 may also have further features/functionality. For example, the device 100 may also include additional storage (removable and/or non-removable) including, but not limited to, magnetic or optical disks or tapes, USB flash drives, memory cards, etc. Such additional storage is illustrated in FIG. 1 by a removable storage 108 and a non-removable storage 110. Computer storage media includes volatile and nonvolatile, removable and non-removable media implemented in any method or technology for storage of information such as computer readable instructions, data structures, program modules or other data. The memory 104, the removable storage 108 and the non-removable storage 110 are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the device 100. Any such computer storage media may be part of the device 100.

System memory 104 may include operating system 130, one or more programming modules or apps 132, and program data 134. Operating system 130, for example, may be suitable for controlling computing device 100's operation. As stated above, a number of program modules 132 and data files 134 may be stored in system memory 104, including operating system 130.

Generally, consistent with disclosed embodiments, program modules or apps may include routines, programs, components, data structures, and other types of structures that may perform particular tasks or that may implement particular abstract data types. Moreover, disclosed embodiments may be practiced with other computer system configurations, including multiprocessor systems, microprocessor-based or programmable consumer electronics, minicomputers, mainframe computers, and the like. Disclosed embodiments may also be practiced in distributed computing environments where tasks are performed by remote processing devices that are linked through a communications network. In a distributed computing environment, program modules may be located in both local and remote memory storage devices.

Furthermore, some disclosed embodiments may be practiced in an electrical circuit comprising discrete electronic elements, packaged or integrated electronic chips containing logic gates, a circuit utilizing a microprocessor, or on a single chip containing electronic elements or microprocessors. Some disclosed embodiments may also be practiced using other technologies capable of performing logical operations such as, for example, AND, OR, and NOT, including but not limited to mechanical, optical, fluidic, and quantum technologies. In addition, some disclosed embodiments may be practiced within a general purpose computer or in any other circuits or systems.

Disclosed embodiments, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the disclosed embodiments may be embodied in hardware and/or in software (including firmware, resident software, micro-code, etc.). In other words, some disclosed embodiments may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain, store, communicate, propagate, or transport the program for use by or in connection with the instruction execution system, apparatus, or device.

As mentioned above, the device 100 has installed therein a media converter card 112 that allows the device to connect to a fiber network 113, for example to a fiber network server including a VoIP sever, through fiber cable 111 connected to device 100. The fiber network 113 can in turn connect to a network 152, such as the Internet, a virtual local area network (VLAN), or other networks. While fiber optic network 113 is illustrated as a single fiber optic network server connected to media converter card 112 through a single fiber optic cable, those of skill in the art will understand that this representation is for purposes of a simplified illustration, and that additional fiber cables, fiber networks servers, or other devices can also be included in fiber optic network 113 and fiber cable 111. Further, in some embodiments where switching NIC card 112 is not configured to perform media conversion between fiber and copper cables, network 113 can be a copper network or other types of networks, and cable 111 can be a copper cable or other types of cable. For example for a copper based PoE NIC card, cable 111 can be a copper cable.

The following description of some exemplary embodiments assumes, for illustrative purposes, that the switching NIC card 112 is a media converter card configured to provide media conversion functionality between a copper network and a fiber network, though disclosed embodiments are not limited to this particular type of switching NIC cards. Media converter card 112 is configured to implement media conversion functions, in both full power and sleep modes of operation of computing device 100, to convert data communicated on fiber cable 111 into data of a format which can be communicated on copper cable, and vice-versa. The copper cable format converted data is used both internally within the computing device 100, and is used to communicate over a copper cable type connection 140 to a peripheral device 142. As described below in greater detail, media converter card 112 can include an RJ-45 type connector, and the copper cable type connection 140 can be a twisted pair copper connection. In exemplary embodiments, peripheral device 142 is an IP phone with an RJ-45 connector. In other exemplary embodiments, peripheral device 142 can be other types of devices, such as IP cameras, wireless access points, etc., for which it can be beneficial to maintain functionality while the computing device is in a sleep mode of operation.

Also shown with computing device 100 are one or more display devices 116, one or more input devices 114, such as a keyboard, mouse, pen, voice input device, etc., for providing other input to the computing device, and one or more other output devices 118 such as speakers, a printer, a vibration generator, etc. All these devices are well known in the art and need not be discussed at greater length here. Further, display device 116, input devices 114 and output devices 118 can all be considered to be separate from, or alternatively part of, computing device 100.

Computing device 100 has a power source 120, such as a power supply, that provides power for computations, communications and so forth by the device 100. Computing device 100 is configured such that power source 120 ultimately provides power for media converter card 112, and can provide power, using power over Ethernet (PoE) technology and standards, to peripheral devices 142 in some embodiments.

As is described further with reference to FIG. 2, in exemplary disclosed embodiments, media converter add-in card 112 is provided with a new arrangement of components and functionality such that, when computing device 100 enters a sleep mode, the media conversion functionality persists, using standby voltage power to provide power to a switching circuit and a local embedded processor. Conventionally, media converter cards have relied upon the processing power of the processing unit of the host PC or computing device to perform or implement the media conversion functionality, and therefore the media conversion functionality has not been available when the PC entered a low power sleep mode. Disclosed embodiments of the media converter add-in card 112 overcome this shortcoming.

Referring now more specifically to FIG. 2, shown is media converter card 112 installed on host computing device 100 via connectors 202 and 204 on the computing device and the media converter card. In exemplary embodiments, connectors 202 and 204 are connectors in accordance with a standard such as the high-speed serial computer expansion bus standard PCIe (Peripheral Component Interconnect Express). In other embodiments, connectors 202 and 204 can be in accordance with other standards. A main 12 V power connector 206 on card 112 connects to a corresponding connector 201 of a bus of computing device 100 which is electrically coupled to, and provides power from, power supply 120. As shown at 208 in FIG. 2, a constant DC (e.g., 12V) supply voltage is provided to card 112 through connector 206. For providing power to PoE compliant devices, a step-up voltage converter 210, typically including a transformer, is connected to the constant supply voltage line. The step-up voltage converter converts the constant supply voltage to a higher constant DC voltage (e.g., 54V) at output 212. Step-up converter 210 typically includes filtering circuitry used to filter one or both of the constant supply voltage provided to the step-up converter or the higher constant voltage provided as an output from the step-up converter, but in other embodiments filtering can be provided by other circuitry.

Media converter card 112 includes, in some exemplary embodiments, a controller 214 which is a combined PoE and power sourcing equipment (PSE) controller configured to receive the stepped up voltage from output 212 of converter 210, and to control the provision of power to a peripheral device 142, such as an IP phone, in accordance with a PoE standard. Output 216 from controller 214 is connected to RJ-45 connector 220 on card 112. In embodiments in which media converter card 112 is configured to provide power to peripheral device 142, connector 220 is a PoE type of RJ-45 connector or port. In embodiments in which media converter card 112 does not support PoE functionality, connector 220 can be a conventional RJ-45 type of Ethernet port. Optionally, peripheral device 142 can have its own power supply 221 in some embodiments in which PoE functionality is not supported, particularly during certain low power modes of operation.

As discussed above with reference to FIG. 1, copper cable(s) 140 electrically connect peripheral device 142 to connector 220. In exemplary embodiments in which device 142 is an IP phone also having an RJ-45 connector, copper cable(s) 140 are twisted pair copper cables having RJ-45 jacks on either end. Controller 214 is, in some embodiments, configured to identify or determine whether a PoE compliant peripheral device is connected to connector 220 such that the device can receive power over an Ethernet cable. This assures that a stepped up voltage is not provided to non-PoE compliant devices.

A second port on the media converter card is fiber optic port 222, which can be a fiber Ethernet port. Fiber optic port 222 connects a fiber optic network server 113, again for example including a VoIP sever, which can be located up to several kilometers away due to the benefits provided using fiber optic technology. The fiber cable connection between port or connector 222 and the fiber optic network is illustrated again at reference number 111.

As shown in FIG. 2, media converter card 112 also has a network interface controller (NIC) 230 connected by bus or electrical connections 229 to the computing device when connectors 202 and 204 are coupled. NIC 230 can utilize flash memory device 232 to store data and operational parameters, and/or NIC can include internal memory to store such data and operational parameters. In exemplary embodiments, NIC 230 is configured to monitor data packets received on bus 229 from computing device 100 for instructions regarding entry into, and exit from, various low power sleep modes of operation.

Media converter card 112 also has standby power circuitry 235, a microcontroller 240, and an Ethernet switch 250. Microcontroller 240 is coupled to computing device 100 through bus or electrical connections 244, which can be the same as bus 229, when connectors 202 and 204 are coupled. The microcontroller 240 and the PSE controller 214 are coupled through a two-way communication line 257 in some exemplary embodiments. Through this connection, the microcontroller 240 can initialize the PSE controller 214 for different modes of operation. The microcontroller 240 determines statuses, for example in response to settings which can be controlled by configuring resistors or jumper wires 242 on the card or by other setting establishing electrical configurations or devices, and responsively instructs the PSE controller 214 which mode or modes of operation to function under. For example, microcontroller 240 can instruct the PSE controller 214 to operate in a PoE mode of operation in accordance with a PoE standard, or the microcontroller 240 can instruct the PSE controller to operate under one or more various legacy modes implemented before a PoE standard was established in the industry. Microcontroller 240 is also connected to the fiber Ethernet port 222 by a signal detect line 254 and a transmit disable line 255. Using these connections, if the IP phone or other peripheral device were unplugged, microcontroller will recognize this unplugged status, disable transmission through port 222, and send a status update to the NIC 230.

Ethernet switch 250 can be an ASIC or other switching circuitry controllable by microcontroller 240 using a communication connection 251 between the devices. In an exemplary embodiment, Ethernet switch 250 is a layer 2/3 1GB switch, but other types of switches can be used as well. In an exemplary embodiment, switch 250 is configured to function with a 3-port operation. One port is configured to communicate with the NIC via communication line 231, one port is configured to communicate with the RJ-45 copper port 220 via communication line 253, and one port is configured to communicate with the fiber Ethernet port 222 via communication line(s) 252. In conventional media converter cards, a dual port NIC has typically been used to provide a switch function of passing data between the two ports which were coupled to the copper and fiber ports of the card, and the processing unit of the host computing device was relied upon to implement the media conversion functionality to convert the data received at one NIC port into the format required at the other NIC port. However, as discussed above, when the host computing device entered a low power or sleep mode of operation, the processing unit of the host computing device was not available and the media conversion function could not be performed. This prevented the IP phone or other peripheral device from communicating with the fiber network (e.g., with a VoIP server). In disclosed embodiments, Ethernet switch 250 is itself, or has a data converter, configured to implement the media conversion functionality, converting data received at either of ports 220 and 222 into the data format required at the other of the ports and respective media.

Standby circuitry 235, which can include one or more diodes, voltage regulators, and/or other components, receives a low voltage (e.g., 3V) supply signal supplied through the PCIe connectors 202 and 204 when the media converter card is installed on the host computing device 100. Under normal full power operation, the host computing device 100 supplies the 12V supply voltage to card 112 to create an isolated 54V that is used to power peripheral device 142 and/or circuitry which enables communication with the peripheral device. When the computing device is in a sleep mode, power must be reduced and this 12V supply voltage is no longer provided. However, the low voltage supply signal supplied through the PCIe connections is still used to provide up to 10 W of power to the media converter card to support wake on LAN functionality which requires the NIC 230 to remain powered. Using this low power supply voltage at connection 236, standby circuitry 235 generates a regulated supply voltage at a level (e.g., 3.3V) required to power microcontroller 240 and Ethernet switch 250 (which may include the data converter in some embodiments), even during the low power sleep modes of operation. This supply voltage is provided at connections 237 shown in FIG. 2.

Thus, in a sleep mode of operation, if the IP phone or other peripheral device 142 is separately powered using its own power supply 221, it is able to communicate with the fiber network 113 while the computing device 100 is asleep. Particularly in the case of an IP phone, this provides great benefit as the phone will remain functional during the sleep mode of the computing device 100. Further, when utilizing a PoE compliant IP phone or peripheral device 142, in some embodiments of the present disclosure, the PoE functionality can persist and the peripheral device can be powered through the media converter card copper Ethernet port 220 if the sleep mode of host computing device 100 is such that main 12 V power is still provided to the media converter card. However, in sleep power modes in which main 12 V power is not provided to the media converter card 112, a separate power supply 221 of the peripheral device can be needed.

In some embodiments, microcontroller 240 is also configured to implement link pass through (LPT) functionality. Typically, when a PC or other computing device is connected to a remotely located Ethernet switch using a fiber optic cable, a media converter will be used at both ends of the fiber optic cable to make the conversion between fiber cable and copper cable. This creates four separate connections. A first between the computing device and a first media converter, a second between the first media converter and the fiber cable, a third between the fiber cable and the second media converter, and a fourth between the second media converter and the Ethernet switch. If any of the four connections fails, it can be difficult to diagnose the problem. Link pass through functionality implemented by microcontroller 240 detects failures at either of ports 220 or 222, and then propagates that failure throughout the entire link. To accomplish this, if media converter card loses link on one of its two ports 220 or 222, the configuration of the microcontroller 240 stops transmission on the other port. The same steps are then implemented on the other end of the fiber cable at the remotely located Ethernet switch. This passes the failure along so that network administrators are aware of the failure.

In exemplary embodiments, the link pass through function has a selectable feature, allowing the link of either port 220 or port 222 to be propagated to the PC or host computing device port 202 to update the link status of the network connection that is reported by the host PC device 100. This type of LPT implementation operates unidirectionally, to support for example the IP phone device 142 with a host PC device 100 in ACPI states S0-S1 or an IP phone device 142 that has external power supply 221 with host PC device 100 Wake on LAN enabled in ACPI states S0-S4, to continue communication with the fiber/network 113 even if the NIC link 202 is down.

In some exemplary embodiments, card 112 is further configured to provide an option that allows the link status of cable 111 to the fiber or other port 222 to reset the PoE power to the device 142 that is connected to copper port 220.

Although the present invention has been described with reference to preferred embodiments, workers skilled in the art will recognize that changes may be made in form and detail without departing from the spirit and scope of the invention. For example, workers skilled in the art will recognize that features of media converter card embodiments can be used on other switching NIC card embodiments, and such other embodiments are within the scope of the disclosure.

1. A media converter, comprising:
a connector, configured to couple to a power supply of the computer, such that the media converter is powered by the power supply;
a first port configured to communicate with a first media;
a second port configured to communicate with a second media; and
a data converter configured to:
convert data received at the first port into a data format communicable by the second port and the second media even when the computer is operating in a low power mode or sleep mode; and
convert data received at the second port into a data format communicable by the first port and the first media even when the computer is operating in a low power mode or sleep mode.

2. The media converter of claim 1, wherein the media converter is part of a card, and wherein the card is configured to attach to and detach from a peripheral component interconnect (PCI) bus of the computer.

3. The media converter of claim 1, wherein the media converter is hardwired to the computer.

4. The media converter of claim 1, wherein the first media and the second media are different types of media.

5. The media converter of claim 1, wherein the first media is a fiber optic cable.

6. The media converter of claim 5, wherein the second media is a copper cable.

7. The media converter of claim 1, further comprising a switch that comprises:
the data converter; and
respective ports configured to communicate with the first port and the second port.

8. The media converter of claim 7, wherein the switch is an Ethernet switch.

9. The media converter of claim 1, further comprising a network interface controller (NIC) that is configured to store data and operational parameters from the computer.

10. The media converter of claim 9, wherein the data and operational parameters from the computer include instructions regarding entry into, and exit from, a low power mode or a sleep mode of the computer.

11. The media converter of claim 1, further comprising standby circuitry that is configured to provide power to the data converter when the computer is operating in a low power mode or sleep mode.

12. The media converter of claim 1, further comprising:
a power sourcing equipment (PSE) controller that is configured to control different modes of operation of the media converter; and
a microcontroller that is configured to:
determine statuses of parts of the media converter; and
instruct the PSE controller which mode of operation of the media converter to operate under.

13. The media converter of claim 12, wherein the modes of operation of the media converter include a power over Ethernet (PoE) mode in accordance with a PoE standard and a legacy mode established prior to the existence of PoE.

14. A media converter card configured to attach to and detach from a bus of a computer, comprising:
a connector, configured to:
couple to a first bus of a computer;
receive power from a power supply via the first bus of the computer, such that the media converter is powered by the power supply;
a first port configured to communicate with a fiber optic cable;
a second port configured to communicate with a copper cable;
a switch, comprising:
respective ports configured to communicate with the first port and the second port; and
a data converter configured to:
convert data received at the first port into a data format communicable by the second port and a copper cable even when the computer is operating in a low power mode or sleep mode; and
convert data received at the second port into a data format communicable by the first port and a fiber optic cable even when the computer is operating in a low power mode or sleep mode; and
standby circuitry configured to:
couple to a second bus of the computer and receive power via the second bus; and
provide power to the switch when the computer is operating in a low power mode or sleep mode.

15. The media converter card of claim 14, further comprising a network interface controller (NIC) that is configured to store data and operational parameters from the computer, wherein the data and operational parameters from the computer include instructions regarding entry into, and exit from, a low power mode or a sleep mode of the computer.

16. The media converter card of claim 15, wherein the NIC is further configured to couple to the second bus of the computer and receive power via the second bus.

17. The media converter card of claim 14, wherein the switch is an Ethernet switch.

18. A method, comprising:
attaching a media converter card to a first bus and a second bus of a computer;
receiving power via the first and second buses of the computer, such that the media converter is powered by the computer;
communicating with a fiber optic cable by a first port of the media converter card;
communicating with a copper cable by a second port of the media converter card;
converting, by a switch, data received at the first port into a data format communicable by the second port and the copper cable even when the computer is operating in a low power mode or sleep mode that effects the power outputted by the first bus;
converting, by a switch, data received at the second port into a data format communicable by the first port and the fiber optic cable even when the computer is operating in the low power mode or sleep mode; and
providing, by standby circuitry, power to the switch when the computer is operating in the low power mode or sleep mode.

19. The method of claim 18, wherein the switch is an Ethernet switch.
